(19) United States
(12) Patent Application Publication
(10) Pub. No.: US 2012/0159230 A1
(43) Pub. Date: Jun. 21, 2012

(54) Mechanism for Updating Memory Controller Timing Parameters During a Frequency Change

(76) Inventor: Hao Chen, San Ramon, CA (US)

(21) Appl. No.: 12/972,033

(22) Filed: Dec. 17, 2010

(51) Int. Cl. G06F 1/04; G06F 12/00

(52) U.S. Cl. 713/600; 711/154; 711/E12.001

(57) ABSTRACT

A mechanism for updating memory controller timing parameters during a frequency change includes a memory controller that controls memory transactions to a memory unit. The integrated circuit may also include a power manager unit that is coupled to the memory controller and may be configured to provide an indication that a memory clock frequency is changing to a new frequency. The integrated circuit also includes a storage that includes a number of entries. Each entry may store a predetermined set of timing values that corresponds to a respective memory clock frequency. In response to receiving the indication, the memory controller may access a given entry of the storage that corresponds to the new frequency, and may generate new timing values that correspond to the new frequency based upon the predetermined set of timing values stored within the given entry.

### BACKGROUND

1. Technical Field

This disclosure relates to memory controllers and more particularly to adapting memory controller timing parameters.

2. Description of the Related Art

Generally speaking, to read and write data to a memory device, a variety of signals must be applied at appropriate times. In addition, for some memory devices such as devices in the dynamic random access memory (DRAM) family of devices, the charge stored within the individual memory cells of the memory device must be refreshed. Most computer systems employ some type of memory controller to provide the signals to perform the read and write transactions and to perform refresh operations.

Some of the transactions and particularly the refresh operations may be time based and thus, frequency dependent. More particularly, most DRAM devices require that a refresh operation be performed on each cell at some periodic interval. For example, some devices require a refresh at least every 64 ms. If a memory controller is operating at a particular clock frequency, and thus all of the timing parameters, including refresh rates, are set up according to that frequency, if that frequency is changed the timing parameters may not be adequate at the new frequency. Accordingly, at least some of the timing parameters may need to be recalculated during the frequency change. However, these calculations may take an unacceptable amount of time, during which the memory bus may be held in an inactive state.

### SUMMARY OF THE EMBODIMENTS

Various embodiments of a mechanism for updating memory controller timing parameters during a frequency change are disclosed. In one embodiment, an integrated circuit includes a memory controller that may be configured to control memory transactions to a memory unit such as DRAM device, for example. The integrated circuit may also include a power manager unit that is coupled to the memory controller and may be configured to provide an indication that a memory clock frequency is changing to a new frequency. The integrated circuit also includes a storage such as a lookup table, for example, that includes a number of entries. Each entry may be configured to store a predetermined set of timing values that corresponds to a respective memory clock frequency. In response to receiving the indication, rather than use old timing values, or recalculate timing values based on the new frequency, the memory controller may access a given entry of the storage that corresponds to the new frequency and may generate new timing values that correspond to the new frequency based upon the predetermined set of timing values stored within the given entry.

In another embodiment, a method includes a memory controller controlling transactions to a memory unit and generating for the memory unit control signal timing values that correspond to a memory clock frequency. The method may also include storing within each entry of a plurality of entries of a storage a predetermined set of timing values that corresponds to a respective memory clock frequency. The method may also include receiving an indication that the memory clock frequency is changing to a new frequency. The method may also include, in response to receiving the indication, accessing a given entry of the storage that corresponds to the new frequency and retrieving the set of timing parameters that corresponds to the new frequency. In addition, the method may include generating new timing values based upon the predetermined set of timing values stored within the given entry.

### BRIEF DESCRIPTION OF THE DRAWINGS

FIG. 1 is a block diagram of one embodiment of an integrated circuit including a memory controller.

FIG. 2 is a block diagram illustrating more detailed aspects of an embodiment of the memory interface of the memory controller shown in FIG. 1.

FIG. 3 is a flow diagram describing operational aspects of an embodiment of the memory controller shown in FIG. 1 and FIG. 2.

FIG. 4 is a block diagram of one embodiment of a system that includes the integrated circuit of FIG. 1.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the art having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation for that unit/circuit/component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION OF THE EMBODIMENTS

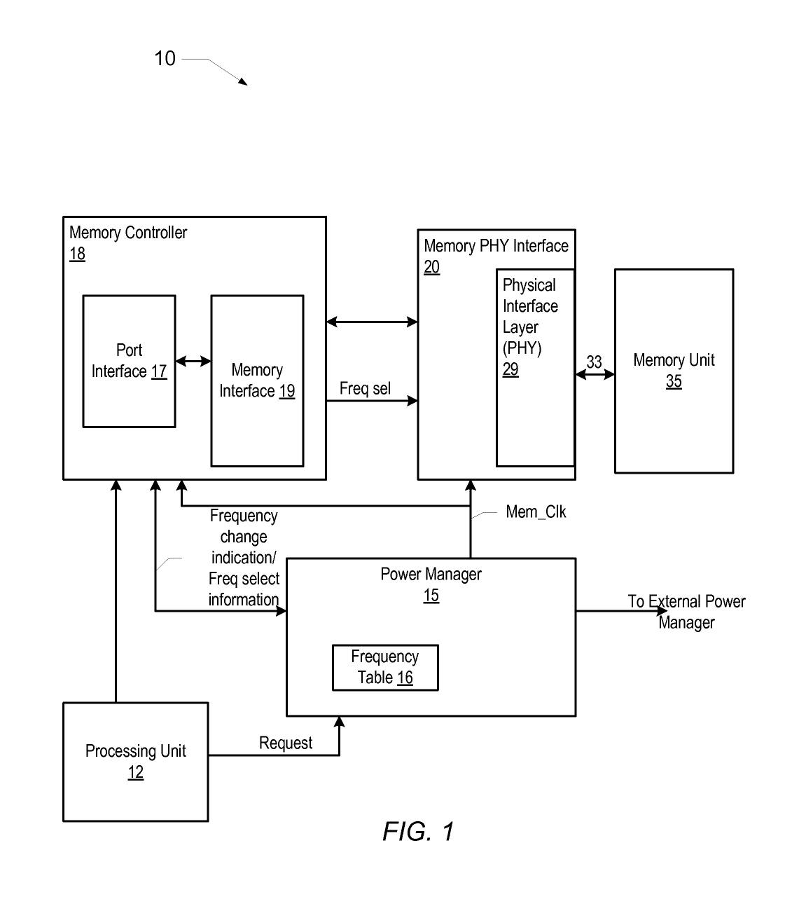

Turning now to FIG. 1, a block diagram of one embodiment of an integrated circuit including a memory interface is shown. The integrated circuit 10 includes a processing unit 12 that is coupled to a power manager 15 and to a memory controller 18. The power manager 15 and the memory controller 18 are also each coupled to a memory PHY interface 20, which is in turn coupled to a memory unit 35 via a memory interconnect 33. In one embodiment, the integrated circuit 10 may be considered as a system on a chip (SOC).

In various embodiments, the processing unit 12 may include one or more processor cores and one or more cache memories (not shown). The processor cores may execute application software as well as operating system (OS) software. The OS may control various features and functions of the integrated circuit. For example, depending on the system performance settings, the OS or other system software may request a change in the frequency of the system clocks, which includes the clocks that drive the memory interconnect 33.

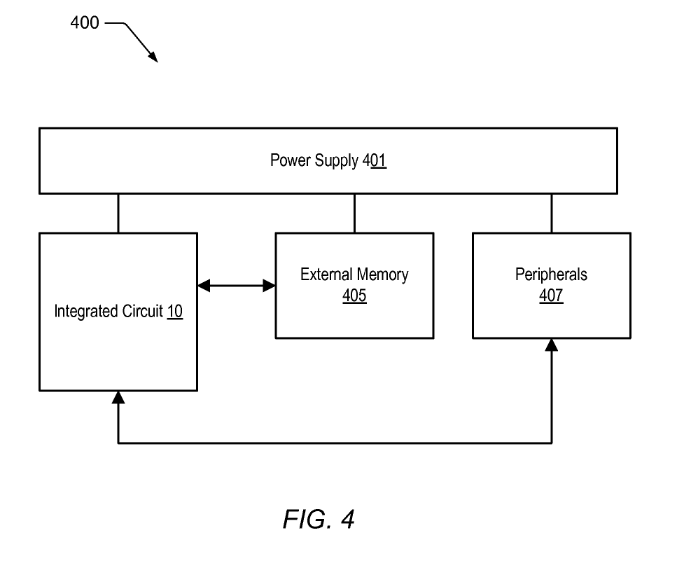

The memory unit 35 may be representative of any type of memory. In one embodiment, the memory unit 35 may be representative of one or more memory devices in the DRAM family of devices as described below in conjunction with the description of FIG. 4. Accordingly, the memory interconnect 33 may include a number of data paths, data strobe paths, and address and command paths (all not shown).

In one embodiment, the power manager 15 is configured to provide clocks for use by the components of integrated circuit 10. As shown, the power manager 15 provides the Mem_Clk signal to the memory controller 18 and to the memory PHY interface 20. The Mem_Clk signal may be used as the memory system core clock and may be used by the memory controller 18, the memory PHY interface 20 and the memory unit 35.

In one embodiment, the memory PHY interface 20 may serve as a control and configuration interface for the physical interface layer (PHY) unit 29. In one embodiment, the PHY 29 may include a delay locked loop (DLL) unit (not shown) that may include one or more DLLs that may be configured to acquire and lock onto a particular edge of a reference clock such as the Mem_Clk signal, for example, and to provide one or more delayed versions of the reference clock for use by the memory interconnect 33.

In one embodiment, the memory controller 18 may be configured to control the operation of the memory unit 35. In the illustrated embodiment, the memory controller 18 includes a port interface 17 and a memory interface 19. In one embodiment, the port interface 17 may be configured to provide a bus interface that includes, for example, transaction reordering according to each bus protocol for the various requesting units that may request memory transactions from the memory controller 18. For example, the port interface 17 may provide a bus interface to a CPU bus such as may be used between the memory controller 18 and processing unit 12, for example.

As will be described further below the memory interface 19 may be configured to arbitrate memory requests within one or more memory channels, maintain memory device system protocol, and schedule the traffic requests with the objective of maximizing the memory device bus utilization. In addition to perform read/write transactions, the memory interface 19 may also observe memory device protocol and timing. In various embodiments, there may be separate engines for activate, column address strobe (CAS), precharge, auto-refresh, and mode register read and write commands (e.g., MRR/MRW). Further, there may be state tracking and managing on a per-rank basis for controlling the memory device states and transitions.

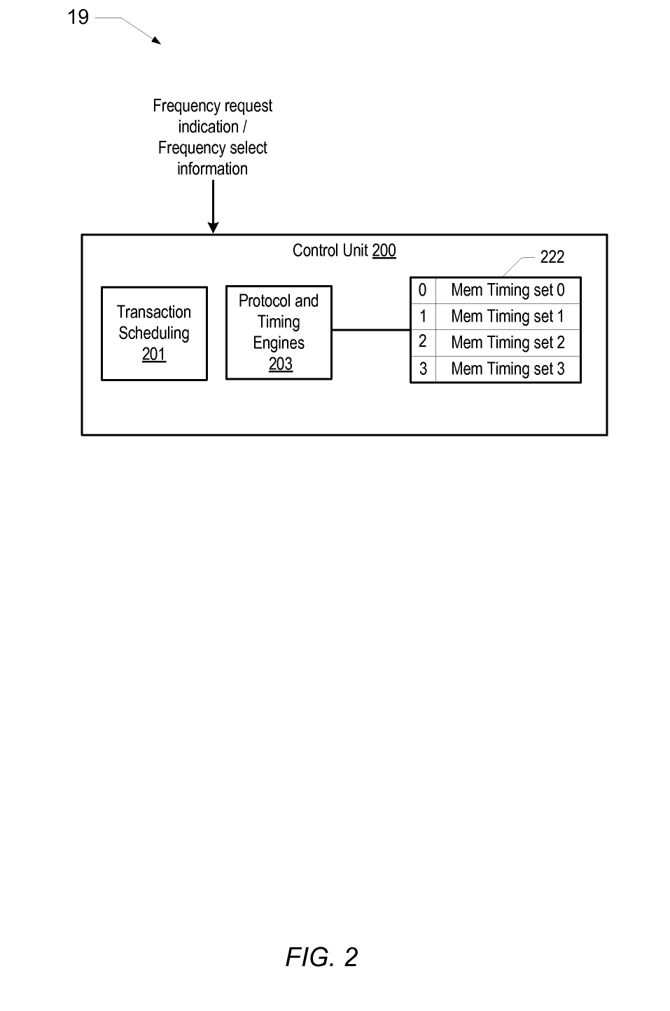

In one embodiment the memory interface 19 may include a look up table (shown in FIG. 2) to store the various timing parameter configurations of the DRAM (memory unit 35) for a number of memory clock operating frequencies. More particularly, as described further below, the power manager 15 may change the frequency of one or more of the system clocks such as the memory core clock, in response to a system request. The power manager 15 may provide a frequency change indication and frequency select information such as a frequency index from, for example, table 16 to the memory controller 18 in response to a request from the processor 12. In response to detecting an assertion of the frequency change indication, the memory controller 18 may initiate a handshake with the power manager 15 to ensure a smooth transition to the new frequency. It is noted that an asserted signal refers to a signal that transitions to its active state. More particularly, if a signal is an active low signal, then it is considered to be asserted when the signal level is at a logic low level. Conversely, if a signal is an active high signal, then it is considered to be asserted when the signal level is at a logic high level.

If a frequency change is requested, the memory controller 18 may be required to quiesce the memory interconnect 33 prior to allowing a frequency change to occur. More particularly, the purpose of the handshake process is to allow the memory controller 18 to quiesce or place the memory interconnect 33 into a state where the clock frequency may be changed per the requirements of the memory unit 35, respond to the power manager 15 so that the power manager may proceed in changing the clock frequency, and hold the memory interconnect 33 in the quiesced state until after the power manager 15 has changed the frequency and has indicated the clock frequency has been changed and is stable. Accordingly, the system software or OS may notify the power manager 15, which in turn asserts the frequency change request indication to the memory controller 18. As part of the handshake, and in response to the request the memory controller 18 may wait until all in-flight memory transactions have completed, and prepare the memory unit 35 by precharging banks, and draining refreshes, for example. In one embodiment, the memory controller 18 may not start any new memory transactions to memory unit 35 after acknowledging the request until the frequency change is complete. The power manager 15 may initiate the frequency change by changing the frequency and providing the memory controller 18 with frequency select information that corresponds to the new frequency. Once the frequency change has been changed and the clock is stable, the power manager 15 may deassert the request, and the memory controller 18 may acknowledge the deassertion. Since the memory interconnect 33 remains idle (for memory requests) until the frequency change is complete, the faster the memory controller 18 can retrain for the new timing, the faster the memory interconnect 33 may be usable again.

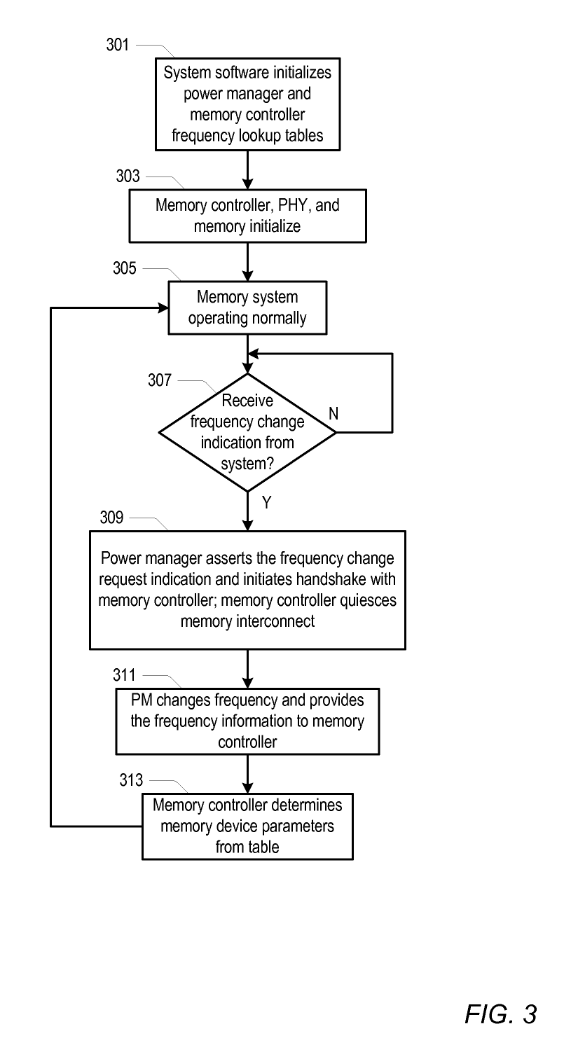

Accordingly, as described in greater detail below in conjunction with the description of FIG. 2 and FIG. 3 in an effort to reduce the time required to change the clock frequency of the memory interconnect 33, in one embodiment the memory controller 18 may use the frequency select information that was provided by the power manager 15 to access a look-up table (shown in FIG. 2), and to use values therein to update the timing parameters of the memory unit 35 for the new frequency without having to recalculate the timing.

Referring to FIG. 2, a block diagram illustrating more detailed aspects of the embodiment of the memory interface 19 of the memory controller 18 of FIG. 1 is shown. Components that correspond to those shown in FIG. 1 are numbered identically for clarity and simplicity. The memory interface 19 includes the control unit 200, which in turn includes a transaction scheduling unit 201 and protocol and timing engines 203. In addition memory interface 19 includes a lookup table 222.

As described above, the control unit 200 may receive the frequency selection signal, and in one embodiment, the frequency request indication. The frequency selection signal may indicate the frequency domain in which the memory controller 18 is operating. In one embodiment, there may be four frequency domains. The four domains include domain 0 which corresponds to the maximum nominal frequency of the memory controller 18 and memory unit 35; domain 1 which corresponds to approximately half of the maximum frequency; domain 2 which corresponds to approximately half of the frequency of domain 1; and domain 3 which corresponds to approximately half of the frequency of domain 2. In one implementation, the domain 0 frequency may be 400 MHz. It is noted that in other embodiments, other numbers of frequency domains and different frequencies may be used.

As shown, the lookup table 222 includes four entries. Each entry corresponds to a frequency domain. Accordingly, in the illustrated embodiment each entry includes a domain field and a timing set field. In one embodiment, the control unit 200 may use the frequency selection signal to index into the lookup table 222.

The timing set field in each entry may be used by the control unit 200 to generate new timing parameters for the memory controller 18 and memory unit 35. More particularly, each timing set may include a number of timing parameters that are used by the memory controller 18. In one embodiment, the protocol and timing engines 203 may include various timers and counters that count clock cycles to generate the various memory timing signals based in real time. Accordingly, when the memory core clock frequency is changed, new count values may be loaded into the timers and counters to establish the same or as close to the same real time signal timing as in the previous frequency domain. For example, column address strobe (CAS) timing, auto-refresh timing, pre-charge timing, and self-refresh timing may be programmed with different count values for each frequency domain. In other embodiments, there may be additional parameters, and/or different parameters, as desired.

Accordingly, in one embodiment, if the memory controller 18 is operating in domain 0 and thus 400 MHz, the control unit 200 may access the domain zero entry and use the values in the timing set 0 to program the timers and counters that control the timing of CAS timing, auto-refresh timing, pre-charge timing, and self-refresh timing, for example. Similarly, if the memory controller 18 is operating in domain 1, the control unit 200 may access the domain one entry and use the values in the timing set 0. Likewise for the remaining domains. The lookup table 222 may be programmed by system software during, for example system initialization. In one embodiment, when the lookup table 222 is programmed, the table 16 within the power manager 16 may also be programmed with the same domain values so that the two units are in synchronization with each other. In one embodiment, the lookup table 222 may initialize with default values out of reset. These values may be overwritten by the system software. It is noted that in various embodiments the lookup table 222 may be implemented using memory such as RAM, or registers, or any type of storage as desired. In addition, in various embodiments the lookup table 222 may be implemented within or external to the memory controller 18 as desired.

In addition, to prevent missing a timing event after the frequency change is accomplished, the timers and counters may be frozen and then loaded with new values from the lookup table 222, or modified values of those look-up table values. Some of the timers and counters of the protocol and timing engines 203 may not be finished counting when a frequency change request is received. Thus, in one embodiment during the quiescing of the memory interconnect 33 the control unit 200 may freeze any such counters that use the programmable timing parameters in the timing sets of table 222. Once those counters are frozen and the clock has stabilized at the new frequency, the values from table 222 that correspond to the new frequency may be loaded into the counters. When the memory controller 18 is back in operation, the counting may resume and the new counter start values will be used. In an alternative embodiment, when the values are read out of table 222, the values may be scaled so that the new count value loaded into the counter is matched to the remaining count value in the old frequency domain. For example, in the old frequency domain, the count value may have been 10 when the counter was frozen. In the new frequency domain the corresponding count value may be 25. Thus, although the actual look up table start value may be different, a count of 25 may be loaded into the counter.

FIG. 3 is a flow diagram describing operational aspects of the memory interface of FIG. 1 and FIG. 2. Referring collectively now to FIG. 1 through FIG. 3 and beginning in block 301 of FIG. 3, upon system initialization, the system software, which in one embodiment may be the OS, may initialize the frequency lookup table 222 and table 16 with the frequency domain values and corresponding memory device timing parameters.

In addition, the memory controller 18, the memory PHY interface and the memory unit 35 may be initialized and calibrated. In one embodiment, the memory unit 35 may run at less than full speed. Accordingly, during initialization, the memory controller 18 and the power manager 15 may participate in an initialization handshake protocol to establish a boot frequency for the memory core clock. Once the initialization sequence is complete, the memory controller 18 may notify the power manager 15 that the normal operating frequency may be used.

During normal operation, the memory system may operate at an established memory core clock frequency (block 305). However, as described above, depending on various parameters such as system utilization, performance requirements, battery voltage, and the like the OS or other component may request a change in the frequency of the memory core clock (e.g., Mem_Clk) (block 307). If the frequency change request is received, the power manager 15 may assert the frequency change indication to initiate a frequency change handshake. During the handshake, the memory controller 18 may quiesce the memory interconnect 33 as described above (block 309). In one embodiment, the memory controller 18 may additionally place the memory device in an auto-refresh mode so that no data will be lost while the memory interconnect 33 is in a quiesced state during the frequency transition.

The power manager 15 changes the frequency of the Mem_Clk signal and provides the frequency select information to the memory controller 18 (block 311). The memory controller 18 may notify the memory PHY interface 20 of the frequency change, and in addition the control unit 200 may use the frequency select information to access the look up table 222 (block 313). The control unit 200 may use the timing information in the look up table 222 to update the memory device timing as described above

In one embodiment, once the memory device timing parameters have been updated, the memory controller 18 may return to a normal operating mode as described above in conjunction with the description of block 305.

Turning to FIG. 4, a block diagram of one embodiment of a system that includes the integrated circuit 10 is shown. The system 400 includes at least one instance of the integrated circuit 10 of FIG. 1 coupled to one or more peripherals 407 and a system memory 405. The system 400 also includes a power supply 401 that may provide one or more supply voltages to the integrated circuit 10 as well as one or more supply voltages to the memory 405 and/or the peripherals 407. In some embodiments, more than one instance of the integrated circuit 10 may be included.

The peripherals 407 may include any desired circuitry, depending on the type of system. For example, in one embodiment, the system 400 may be included in a mobile device (e.g., personal digital assistant (PDA), smart phone, etc.) and the peripherals 407 may include devices for various types of wireless communication, such as WiFi, Bluetooth, cellular, global positioning system, etc. The peripherals 407 may also include additional storage, including RAM storage, solid-state storage, or disk storage. The peripherals 407 may include user interface devices such as a display screen, including touch display screens or multitouch display screens, keyboard or other input devices, microphones, speakers, etc. In other embodiments, the system 400 may be included in any type of computing system (e.g. desktop personal computer, laptop, workstation, net top etc.).

The system memory 405 may include any type of memory. For example, as described above in conjunction with FIG. 1, the system memory 405 may be in the DRAM family such as synchronous DRAM (SDRAM), double data rate (DDR, DDR2, DDR3, etc.), or any low power version thereof. However, system memory 405 may also be implemented in SDRAM, static RAM (SRAM), or other types of RAM, etc.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An integrated circuit comprising:
a memory controller configured to control memory transactions to a memory unit;
a power manager unit coupled to the memory controller and configured to provide an indication that a memory clock frequency is changing to a new frequency; and
a storage including a plurality of entries, wherein each entry is configured to store a predetermined set of timing values that corresponds to a respective memory clock frequency;
wherein in response to receiving the indication, the memory controller is configured to access a given entry of the storage that corresponds to the new frequency and to generate new timing values that correspond to the new frequency based upon the predetermined set of timing values stored within the given entry.

2. The integrated circuit as recited in claim 1, wherein the memory controller includes a control unit configured to access the storage and to retrieve the set of timing parameters that corresponds to the new frequency.

3. The integrated circuit as recited in claim 2, wherein the memory controller includes one or more timers, wherein in response to retrieving the set of timing parameters that corresponds to the new frequency, the memory controller is configured to load one or more values in the set of timing parameters into the one or more timers.

4. The integrated circuit as recited in claim 1, wherein the storage is programmable during an initialization of the memory controller.

5. The integrated circuit as recited in claim 1, wherein the storage comprises a lookup table that is programmable during an initialization of the memory controller.

6. The integrated circuit as recited in claim 1, wherein the indication includes information corresponding to the new frequency.

7. The integrated circuit as recited in claim 1, wherein the power management unit is configured to generate the memory clock and to change the memory clock frequency.

8. The integrated circuit as recited in claim 1, wherein each set of timing parameters includes a value that corresponds to refresh timing for the memory unit.

9. The integrated circuit as recited in claim 1, wherein the memory controller is configured to participate in a handshake protocol with the power manager unit and to notify the power management unit when the memory controller is ready for the frequency change.

10. The integrated circuit as recited in claim 9, wherein the memory controller is configured to complete all transactions that have been initiated between the memory controller and the memory unit prior to notifying the power manager unit.

11. A method comprising:
a memory controller controlling transactions to a memory unit and generating for the memory unit control signal timing values that correspond to a memory clock frequency;
storing within each entry of a plurality of entries of a storage a predetermined set of timing values that corresponds to a respective memory clock frequency;
receiving an indication that the memory clock frequency is changing to a new frequency; and
wherein in response to receiving the indication, accessing a given entry of the storage that corresponds to the new frequency and retrieving the set of timing parameters that corresponds to the new frequency; and
generating new timing values based upon the predetermined set of timing values stored within the given entry.

12. The method as recited in claim 11, wherein generating new timing values includes loading one or more values in the set of timing parameters into one or more timers.

13. The method as recited in claim 12, further comprising programming at least some of the entries in the storage during an initialization of the memory controller.

14. The method as recited in claim 11, further comprising initiating a handshake with a power manager unit in response to receiving the indication that the memory clock frequency is changing.

15. The method as recited in claim 14, further comprising waiting for all transactions that have been initiated between the memory controller and the memory unit to complete prior to notifying the power manager unit.

16. An integrated circuit comprising:
a memory controller including:
a control unit configured to control memory transactions to a memory unit and to generate control signal timing based upon a memory clock frequency;
a programmable storage including a plurality of entries and coupled to the control unit, wherein each entry is configured to store a predetermined set of timing values that corresponds to a respective memory clock frequency;
wherein in response to receiving an indication that a memory clock frequency is changing to a new frequency, the control unit is configured to:
access a given entry of the storage that corresponds to the new frequency;
retrieve from the given entry the set of timing parameters that corresponds to the new frequency; and
generate new timing values based upon the predetermined set of timing values stored within the given entry.

17. The integrated circuit as recited in claim 16, wherein the memory controller includes one or more timers, wherein the memory controller is configured to load one or more values from the set of timing parameters retrieved from the given entry into the one or more timers.

18. The integrated circuit as recited in claim 17, wherein the memory controller is configured to freeze particular timers of the one or more timers that have not completed counting operations and to load the one or more values into the particular timers.

19. The integrated circuit as recited in claim 16, wherein each set of timing parameters includes a value that corresponds to column address strobe timing for the memory unit.

20. A mobile communications device comprising:
a memory device; and
an integrated circuit coupled to the memory device, wherein the integrated circuit includes:
a memory controller configured to control memory transactions to the memory device and to generate control signal timing based upon a memory clock frequency;
a storage including a plurality of entries, wherein each entry is configured to store a predetermined set of timing values that corresponds to a respective memory clock frequency; and
a power manager unit coupled to the memory controller and configured to provide an indication that memory clock frequency is changing to a new frequency;
wherein in response to receiving the indication, the memory controller is configured to:
access a given entry of the storage that corresponds to the new frequency;
retrieve from the given entry the set of timing parameters that corresponds to the new frequency; and
generate new timing values based upon the predetermined set of timing values stored within the given entry.
